(19) United States
(12) Patent Application Publication
(10) Pub. No.: US 2012/0195210 A1
(43) Pub. Date: Aug. 2, 2012

(54) SYSTEM AND METHOD FOR COORDINATING FEMTO INTERFERENCE IN A NETWORK ENVIRONMENT

(75) Inventor: Mark Grayson, Maidenhead (GB)

(73) Assignee: Cisco Technology, Inc.

(21) Appl. No.: 13/019,659

(22) Filed: Feb. 2, 2011

(51) Int. Cl. H04W 24/00

(52) U.S. Cl. 370/252

(57) ABSTRACT

An example method includes receiving interference information associated with a plurality of femto access points operating in a macro network; evaluating the interference information; determining that an interference threshold has been exceeded based on the interference information; and communicating signaling information to a particular femto access point to reduce an interference level based on the interference information.

### TECHNICAL FIELD

This disclosure relates in general to the field of communications and, more particularly, to coordinating femto interference in a network environment.

### BACKGROUND

Networking architectures have grown increasingly complex in communication environments. Femto cells have gained recent notoriety due to their capabilities. In general terms, femto cells represent wireless access points that operate in licensed spectrum to connect mobile devices to a mobile operator's network (e.g., using broadband connections). For a mobile operator, the femto cells offer improvements to both coverage and capacity: particularly indoors. There may also be opportunities for new services, while reducing the overall cost of providing network access. Femto cells can also offer an alternative way to deliver the benefits of fixed-mobile convergence. For many femto scenarios, interference can pose a number of problems for end users and network operators alike.

### BRIEF DESCRIPTION OF THE DRAWINGS

To provide a more complete understanding of the present disclosure and features and advantages thereof, reference is made to the following description, taken in conjunction with the accompanying figures, where like reference numerals represent like parts, in which:

FIG. 1 is a simplified block diagram of a communication system for coordinating femto interference in a network environment in accordance with one embodiment of the present disclosure;

FIGS. 2-3 are simplified block diagrams illustrating example network cells associated with the communication system of FIG. 1; and

FIG. 4 is a simplified flowchart that illustrates example activities associated with femto interference coordination in a network environment in accordance with one embodiment of the present disclosure.

### DETAILED DESCRIPTION OF EXAMPLE EMBODIMENTS

### Overview

A method is provided in one example embodiment and includes receiving interference information associated with a plurality of femto access points operating in a macro network; evaluating the interference information; determining that an interference threshold has been exceeded based on the interference information; and communicating signaling information to a subset of particular femto access points to reduce an interference level based on the interference information.

The interference information can include rise over thermal (RoT) data. The interference information can be indicative of interference levels generated by UEs attached to the plurality of femto access points. The method can further include establishing a connection between a femto management system and the particular femto access point in order to communicate the signaling information. Additionally, the signaling information can include instructions for reducing the interference level. In particular example implementations, a particular femto access point reduces the interference level by degrading a service associated with one or more specific user equipment (UEs).

In more specific implementations, an identifier, which is associated with a macrocell in which the plurality of femto cell access points are located, is used to generate an identity for establishing a communication session to communicate the signaling information. In a further specific implementation, the macrocell identifier can be embedded into a fully qualified domain name (FQDN), and is used to generate an identity for establishing a communication session to communicate the signaling information.

### Example Embodiments

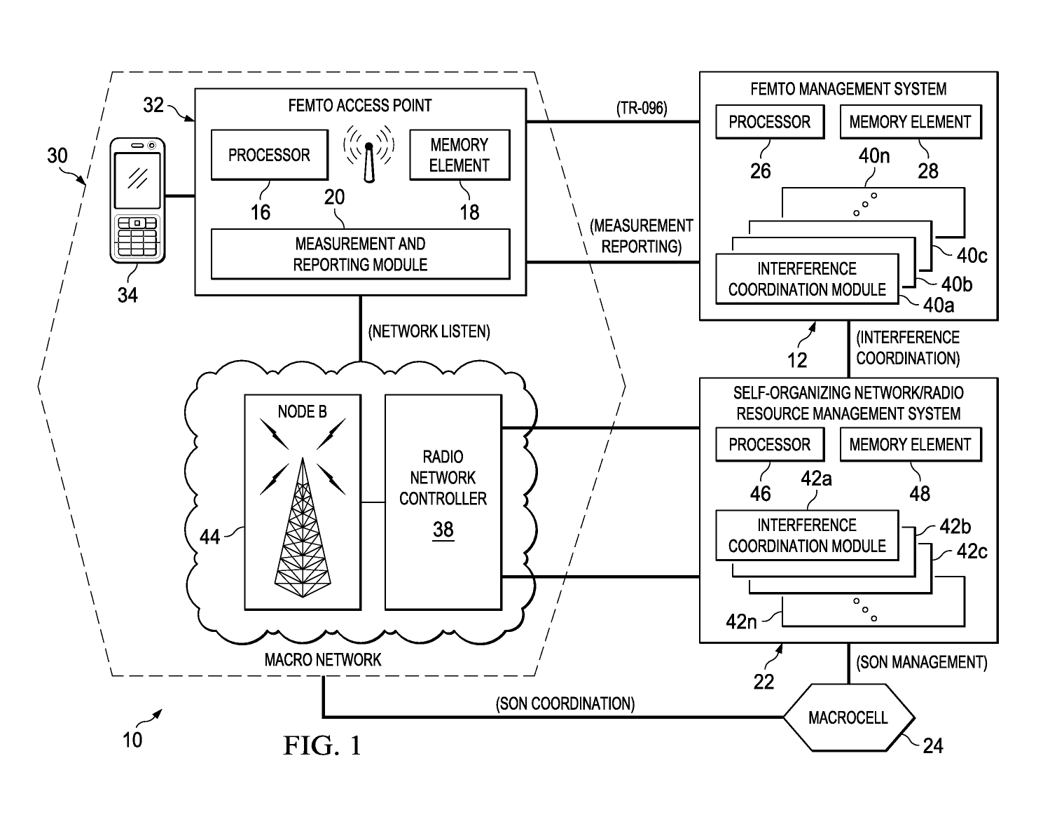

Turning to FIG. 1, FIG. 1 is a simplified block diagram of a communication system 10 for coordinating femto interference in a network environment. FIG. 1 includes a femto management system 12, a self-organizing network (SON)/radio resource management system 22, a macro network 30, a femto access point 32, a mobile node 34, and a radio network controller (RNC) 38, which is configured to interface with a Node B 44. Femto management system 12 may include a processor 26, a memory element 28, and a plurality of interference coordination modules 40a-n. Similarly, SON/radio resource management system 22 may include a processor 46, a memory element 48, and a plurality of interference coordination modules 42a-n. Additionally, femto access point 32 may include a processor 16, a memory element 18, and a measurement and reporting module 20. FIG. 1 could represent a traditional wideband code division multiple access (WCDMA) deployment. A protocol could exist within the architecture such that broadcasting occurs between various elements within the system to optimize operations.

Also depicted in FIG. 1 is a macrocell 24, which has a logical connection to macro network 30 and to SON/radio resource management system 22. SON coordination exists between macro network 30 and macrocell 24. In addition, SON management occurs between SON/radio resource management system 22 and macrocell 24. As shown in FIG. 1, interference coordination modules 40a-n and 42a-n can interact in order to exchange information, which may include measurement reporting data. Femto access point 32 and femto management system 12 can also interact in order to exchange data involving Internet protocol (IP) communications (e.g., data associated with technical report (TR)-196 protocols).

Note that before detailing some of the operational aspects of FIG. 1, it is important to understand common interference characteristics of femto architectures. The following foundational information is offered earnestly for purposes of teaching and example only and, therefore, should not be construed in any way to limit the broad teachings of the present disclosure. In many architectures, femto cells are deployed as autonomous units with rules defining how to configure the radio of the femto units. Handsets that are attached to (and in communications with) femto cells affect the service of the corresponding macrocells. For example, the attached user equipment's (UE's) transmission to a femto cell can raise the thermal noise experienced by a macro base station.

In at least one generic sense, this thermal noise is a form of interference and, in certain instances, includes rise over thermal (RoT) metrics. Hence, the terminology ‘interference information’ as used herein in this Specification is broad and is inclusive of RoT data (i.e., any appropriate RoT information), noise generally, and any other characteristic that may degrade or otherwise negatively affect wireless communications. In wireless communication systems, the RoT represents the ratio between the total power received from wireless sources at a base station and the prevalent thermal noise. The RoT typically measures congestion in a cellular network. For example, the capacity of systems employing code division multiple access (CDMA) is often determined by the acceptable level of RoT. Logistically, a single femto access point does not adversely impact the macro network by itself. However, multiple femto access points (in the aggregate, where a large number of UEs are attached to (and in active communication with) the femto access points) can cumulatively affect the performance of the macro network.

In order to limit such RoT noise, rules should be provided to the femto access point (AP) to determine the maximum transmit power, which can be used by user equipment (e.g., an attached handset) when communicating with the femto AP. These autonomous rules should be conservative: accounting for the possibly large number of femto cells contributing to the interference of the macrocell and accounting for the number of handsets instantaneously transmitting attached to those femto APs. Simplistic averaging rules fail to yield an optimum configuration that limits macro interference, while maximizing femto throughput.

Additionally, it should be noted that in typical CDMA applications, codes can be used to extract signals from the noise in the network. Under ideal situations, some types of codes are perfectly orthogonal: meaning that interference is negated. However, under typical RF channel conditions, there is a lack of orthogonality such that the mobiles employing different codes can contribute noise to the architecture.

In accordance with the teachings of the present disclosure, communication system 10 is configured to offer a femto interference coordination management (FICM) mechanism for network architectures. The architecture is configured to dynamically allocate up-link power information to the femto access points in order to manage the rise over thermal interference (of the cumulative effect) of attached user equipment. In one particular example, an interference coordination module is provisioned for each macro base station. Each of the femto access points of the system is configured to identify an appropriate interference coordination module for reporting certain interference characteristics. Moreover, communication system 10 can include a mechanism for FICM discovery/communication initialization and a FICM/femto operation, which intelligently limits the cumulative interference of femto cells on the macrocell.

The FICM can be defined to operate on a per macro-cellular basis in certain example implementations. The FICM can operate in real-time and offer coordination services between the femto cells within a macrocell. Operationally, the FICM intelligently coordinates the RoT interference generated by a plurality of UEs attached to a plurality of femto cells within a macrocell. Each femto cell can be responsible for establishing a communication session with a logical FICM that covers the macrocell in which it is located. In one embodiment, the femto access point can leverage the macrocell ID to create an FICM identity, which it then uses to establish communications with the FICM. In one embodiment, the macrocell ID in which the femto is located is embedded into a fully qualified domain name (FQDN) for use with a domain name system (DNS) system.

The features of communication system 10 can operate to provide dynamic RoT limits, which can increase femto throughput and coverage. Additionally, the capabilities of communication system 10 allow femto cells to be applied in a greater range of deployments, which includes outdoor applications. Additionally, the features of communication system 10 offer a cellular operator real-time control of macro interference characteristics. In logistical terms, these aspects of communication system 10 offer the ability to deploy denser femto cells.

In operation, femto access point 32 is configured to be responsible for estimating the level of interference that each attached UE is generating. The estimation may use: i) the path loss estimation between the femto and the macrocell (e.g., derived from network listen capabilities); ii) measurement reports from the UE commanded by the femto cell on the macrocell; iii) broadcast information from the macrocell recovered by the network listen that enables the radiated power of the macro base station to be determined; and iv) the UE transmit power commanded by the femto AP.

A network administrator or an operator can be responsible for configuring the FICM with the maximum allowable RoT interference due to the cumulative impact of the UEs attached to (and communicating with) femto cells. Each femto access point can be responsible for communicating with the FICM. For example, when an attached UE requests the establishment of a session, the femto access point can request the FICM to provide RoT information. In one embodiment, the FICM can indicate whether total RoT interference has exceeded a threshold. In addition, the FICM can indicate the reduced RoT limits to apply to the attached UE.

A femto access point receiving an indication that the RoT threshold has been crossed can perform any number of operations to reduce the emitted power associated with its connected UEs. For example, the femto access point can amend its algorithms that control the uplink power of the attached UE such that consequential RoT interference is less than that which would normally occur.

Logistically, a femto access point that has one or more UEs actively transmitting (and, hence, is contributing to the RoT interference of the macrocell) can be in continuous communication with the FICM. The FICM can further be configured to rebalance the RoT interference between attached femto cells. For example, this can include providing updated RoT limits to femto access points with already active UEs. In such cases, the femto access points can be operable to update their algorithms to ensure the RoT is suitably reduced. Similarly, the FICM can be configured to indicate that previous RoT restrictions have been removed: allowing the power control algorithm for sessions for ongoing UEs to be updated.

Essentially, when operating over the threshold interference setting, it can be left up to the individual femto access points, or the FICM rules to determine how to handle new UE requests. For example, the FICM can broadcast (to the femto access points) messages to decrease transmission power. Alternatively, call admission control (CAC) approaches can be used to deny access to UEs, or some hybrid approach can be employed. Alternatively, the FICM may be operable to bias the decrease in power between the attached Femto APs, for example signaling outdoor APs to decrease their interference in preference to indoor units.

Note that the interference activities described herein could address any type of femto system (e.g., including long-term evolution (LTE) architectures). The descriptions below discuss a WCDMA system, but other architectures (e.g., OFDMA) can readily employ the teachings described herein. Virtually any system that seeks to intelligently manage (i.e., coordinate) interference could readily adopts the teachings of the present disclosure.

Before turning to additional operations of this architecture, a brief discussion is provided about some of the infrastructure of FIG. 1. Mobile node 34 can be associated with clients or customers wishing to initiate a communication in communication system 10 via some network. The term ‘mobile node’ is interchangeable with the terminology ‘user equipment (UE)’, where such terms are inclusive of devices used to initiate a communication, such as a computer, a personal digital assistant (PDA), a laptop or electronic notebook, a cellular telephone, an i-Phone, an i-Pad, a Google Droid, an IP phone, or any other device, component, element, or object capable of initiating voice, audio, video, media, or data exchanges within communication system 10. Mobile node 34 may also be inclusive of a suitable interface to the human user, such as a microphone, a display, a keyboard, or other terminal equipment. Mobile node 34 may also be any device that seeks to initiate a communication on behalf of another entity or element, such as a program, a database, or any other component, device, element, or object capable of initiating an exchange within communication system 10. Data, as used herein in this document, refers to any type of numeric, voice, video, or script data, or any type of source or object code, or any other suitable information in any appropriate format that may be communicated from one point to another.

Femto management system 12 is a network element configured to interface with femto access point 32. In one example, as femto access point 32 powers on, it reports its hardware configuration, (e.g., indoor or outdoor unit, maximum number of simultaneously supported transmitting UEs, etc.), geolocation information and receives (from femto management system 12) resource allocations. In one embodiment, these resources can refer to scrambling code allocation information for WCDMA femto cells. In another embodiment, these resources can refer to sub-carriers assignments for Orthogonal Frequency-Division Multiple Access (OFDMA) femto cells. The configuration of FIG. 1 may be dynamically updated (e.g., based on information exchanged with femto management system 12). Note that in certain implementations, the teachings of the present disclosure may be achieved without involving self-organizing network system 22.

Macro network 30 represents a series of points or nodes of interconnected communication paths for receiving and transmitting packets of information that propagate through communication system 10. Macro network 30 offers a communicative interface between mobile node 34 and selected nodes in the network, and may be any local area network (LAN), wireless local area network (WLAN), metropolitan area network (MAN), wide area network (WAN), virtual private network (VPN), Intranet, extranet, or any other appropriate architecture or system that facilitates communications in a network environment. Macro network 30 may implement a user datagram protocol (UDP)/internet protocol (UDP/IP) connection and use a transmission control protocol (TCP/IP) communication language protocol in particular embodiments of the present disclosure. However, macro network 30 may alternatively implement any other suitable communication protocol for transmitting and receiving data packets within communication system 10.

Macro network 30 includes a given coverage area for servicing multiple end users and for managing their associated connectivity. Macro network 30 represents one or more macrocells, which can provide access to a group of mobile nodes 34. Macro network 30 could have a multitude of femto cells (for example, Node B 44 may provide macro coverage over an area including 1000 femto cells). In this example of FIG. 1, macro network 30 includes femto access point 32. A single cell could have multiple neighbors such that femto access point 32, for example, could include information describing the various neighboring cells in its signaling messages.

In one example implementation, femto access point 32 is a small cellular base station designed for use in residential or business environments. Femto access point 32 can connect to the service provider's network (e.g., macro network 30) via broadband (such as Digital subscriber line (DSL), WiMAX, WiFi, cable, etc.) in one example. Femto access point 32 can offer an access point base station, and support multiple active mobile nodes in a given setting (e.g., business, residential, etc.). In one example implementation, femto access point 32 communicates with mobile node 34 over a radio interface using licensed spectrum and, further, connects to the mobile network infrastructure over a fixed broadband connection. The femto cell can allow a service provider to extend service coverage indoors, especially where access would otherwise be limited or unavailable. The femto cell can incorporate the functionality of a typical base station, but extend it to allow a simpler, self-contained deployment. An example implementation of femto access point 32 is a Universal Mobile Telecommunications System (UMTS) femto cell containing a Node B and an RNC with Ethernet for backhaul. The concepts presented herein are applicable to all standards, including GSM, CDMA2000, TD-SCDMA, WiMAX, Long-Term Evolution (LTE), etc.

Example embodiments can include location derivation for the femto cell. For example, femto access point 32 may include a geolocation functionality and report this information to the network (e.g., during provisioning). As used herein in this Specification, the term ‘geolocation’ is meant to encompass various technologies that help to identify the location of a mobile node, end user, etc. This may include global positioning system (GPS) protocols, triangulation of radio waves approaches, or protocols that can track an Internet Protocol (IP) address, a media access control (MAC) address, various RFID elements, hardware embedded via an article/production number, embedded software, etc. In other examples, such geolocation information may be associated with Wi-Fi connection locations, GPS coordinates, or self-disclosed information.

In operation, a typical femto deployment could include sub-carrier allocations being configured for a femto cell. As part of its power up procedure, the femto cell can tune its receiver and then monitor the power associated with each sub-carrier allocation. In one configuration, the femto cell can elect one of the sub-carrier blocks having the lowest power measurement in order to preserve interference characteristics. Femto cells can power on and contact a management system for a list of defined sub-carrier allocations. The sub-carrier allocation with the lowest interference characteristics could be selected. The sub-carriers may be similarly used by the macrocell. In this regard, it is evident that the femto cell carrier allocation and the macrocell allocation coincide, where the emissions generated by the UEs attached to the plurality of femto APs can interfere with the reception of UEs attached to the macro cell.

RNC 38 generally operates as a management component for a radio interface. This management may be done through remote commands to a corresponding Node B within a mobile network. Some of the responsibilities of radio network controllers may include management of radio channels, providing measurement report commands, and assisting in handoff/handover scenarios. RNC 38 can alternatively provide for outer loop power control, load control, admission control, packet scheduling, security functions, etc.

In operation, femto management system 12 is operable to combine information from a plurality of femto access points 32 operating in a specific geolocation. Femto management system 12 may be operable to signal self-organizing network system 22, including information pertaining to the resources required by the collection of femto cells under its management and the geolocation area of said collection of cells. Self-organizing network system 22, in cooperation with femto management system 12, can determine the optimal allocation of resources between those allocated to femto access points 12 and the macro Node Bs. Alternatively, information may be manually configured in femto management system 12.

Node B 44 can offer a communications interface between mobile node 34 and RNC 38. Node B 44 could include a base transceiver station and a base station controller in one embodiment. The communications interface provided by the radio access network of Node B 44 may allow data to be exchanged between an end user and any number of selected elements within communication system 10. Node B 44 may facilitate the delivery of a request packet generated by mobile node 34 and the reception of information sought by an end user. Node B may include an interface to user devices to support optional SON operation. The Node B signals end user devices to perform measurements in order to determine its local operating environment, for example, which can be used to determine when an end user (attached to Node B 44) is located in the vicinity of a femto access point.

Node B 44 is only one example of a communications interface for an end user to use. Other suitable types of communication interfaces may be used for any appropriate network design and, further, be based on specific communications architectures in accordance with particular needs. SON/radio resource management system 22 can optimize network communications and be configured to interface with Node B 44. Node B 44 may comprise radio transmission/reception devices, components, or objects, and antennas. Node B 44 may be coupled to radio network controllers (via one or more intermediate elements) that use a landline (such as a T1/E1 line, for example) interface. Node B 44 may operate as a series of complex radio modems where appropriate. Node B 44 may also perform transcoding and rate adaptation functions in accordance with particular needs.

In one example implementation, SON/radio resource management system 22, femto access point 32, and femto management system 12 are network elements that facilitate or otherwise help coordinate interference management (e.g., for networks such as those illustrated in FIG. 1). As used herein in this Specification, the term ‘network element’ is meant to encompass network appliances, servers, routers, switches, gateways, bridges, loadbalancers, firewalls, processors, modules, base stations, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In one example implementation, femto access point 32, and/or femto management system 12 include software (e.g., as part of interference coordination modules 40a-n and 42a-n, and measurement and reporting module 20) to achieve the interference management operations, as outlined herein in this document. In other embodiments, this feature may be provided external to these elements, or included in some other network device to achieve this intended functionality. Alternatively, both elements include software (or reciprocating software) that can coordinate in order to achieve the operations, as outlined herein. In still other embodiments, one or both of these devices may include any suitable algorithms, hardware, software, components, modules, interfaces, or objects that facilitate the operations thereof.

In regards to the internal structure associated with communication system 10, each of femto access point 32, femto management system 12, and SON/radio resource management system 22 can include memory elements for storing information to be used in achieving the interference management operations, as outlined herein. Additionally, each of these devices may include a processor that can execute software or an algorithm to perform the interference management activities as discussed in this Specification. These devices may further keep information in any suitable memory element [random access memory (RAM), read only memory (ROM), an erasable programmable read only memory (EPROM), an electrically erasable programmable ROM (EEPROM), etc.], software, hardware, or in any other suitable component, device, element, or object where appropriate and based on particular needs. Any of the memory items discussed herein should be construed as being encompassed within the broad term ‘memory element.’ The information being tracked or sent by femto management system 12, femto access point 32, and/or SON/radio resource management system 22 could be provided in any database, register, control list, or storage structure: all of which can be referenced at any suitable timeframe. Any such storage options may be included within the broad term ‘memory element’ as used herein in this Specification. Similarly, any of the potential processing elements, modules, and machines described in this Specification should be construed as being encompassed within the broad term ‘processor.’ Each of the network elements and mobile nodes can also include suitable interfaces for receiving, transmitting, and/or otherwise communicating data or information in a network environment.

Note that in certain example implementations, the interference management functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, memory elements [as shown in FIG. 1] can store data used for the operations described herein. This includes the memory elements being able to store software, logic, code, or processor instructions that are executed to carry out the activities described in this Specification. A processor can execute any type of instructions associated with the data to achieve the operations detailed herein in this Specification. In one example, the processors [as shown in FIG. 1] could transform an element or an article (e.g., data) from one state or thing to another state or thing.

In another example, the interference management activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an EPROM, an EEPROM) or an ASIC that includes digital logic, software, code, electronic instructions, or any suitable combination thereof.

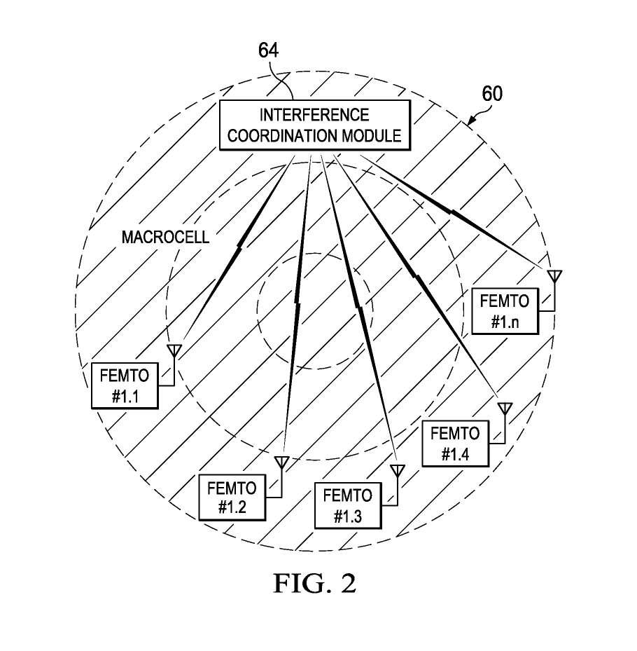

FIG. 2 is a simplified schematic diagram illustrating one arrangement of femto access points. Note that the femto access points FIG. 2 are associated with a same macrocell 60. In this particular illustration, an interference coordination module 64 is included in the wireless environment. Interference coordination module 64 is configured to receive certain interference characteristics from the depicted femto access points, which are labeled #1.1-#1.n in this particular example. For example, each respective femto access point of FIG. 2 may relay its respective estimated RoT levels (e.g., due to attached UEs) to interference coordination module 64, which can evaluate certain thresholds in order to determine whether the reported interference levels are acceptable (e.g., have not exceeded a designated threshold).

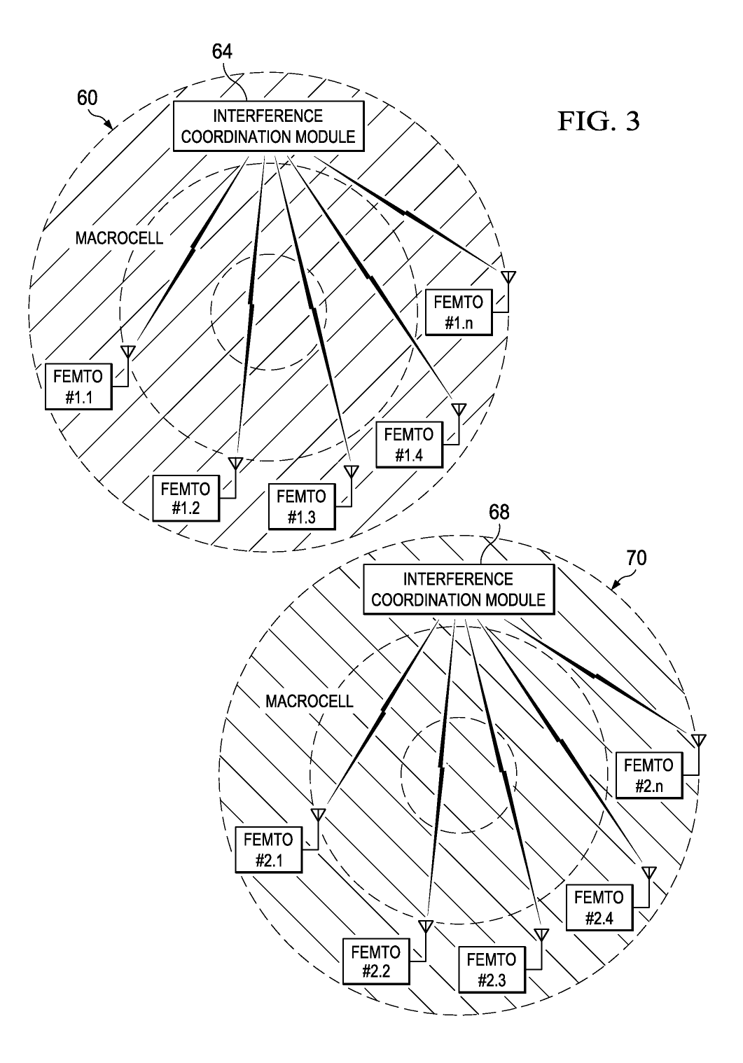

FIG. 3 is a simplified schematic diagram illustrating another arrangement of femto access points. In this particular example, a neighboring macrocell 70 is provided along with macrocell 60. In this particular example, an interference coordination module 68 is included in the environment. Interference coordination module 68 is configured to receive certain interference characteristics from the depicted femto access points, which are labeled #2.1-#2.n. Note that the femto access points of macrocell 60 and of macrocell 70 report their interference characteristics (e.g., RoT characteristics) to their own separate (and independently provisioned) interference coordination module 64 and interference coordination module 68. Stated differently, each macrocell has its own logical instance of an interference coordination module for receiving RoT characteristics from the femto access points for which it is responsible.

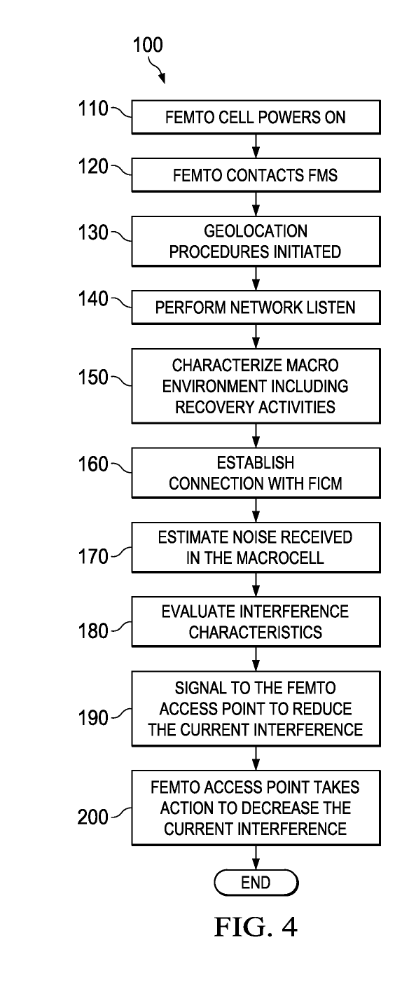

FIG. 4 is a simplified flow diagram illustrating one example operation 100 associated with communication system 10. Beginning at 110, a femto access point can initially be powered on. At 120, the femto access point can contact femto management system 12. At 130, geolocation procedures can be initiated in this particular example. Subsequently, the femto cell can perform network listening functions at step 140. Any of these operating activities can be assisted by measurement and reporting module 20. At 150, a characterization can be made for the macro environment (e.g., as to the location or the edge on which the femto resides, fractional frequency re-use, path loss associated with the macrocell, etc.). Hence, at 150, the macro environment is characterized, where this activity can include recovering the macro identity of certain components covering the user.

At 160, a connection is established with the femto interference coordination module. At this juncture, the architecture can wait for certain handsets to join the femto access points. At 170, an estimate is performed for the noise being received by the macrocell from the attached device. This can include evaluating path loss between the femto access point and the macro network, measurement reports from the UE, broadcast information from the macrocell recovered by the network listen, or any other suitable parameter that may be relevant to interference.

At 180, interference characteristics can be evaluated, which can include evaluating cumulative interference characteristics in comparison to certain designated thresholds (i.e., that may have been preconfigured and/or designated by a network administrator). Depending on provisioning, each femto access point may be allocated a certain share of interference (e.g., as a percentage or as an average of the total permissible interference). In one sense, there is a certain setting of allowable interferences for each access point. Note that certain femto access points may have a single UE attached to them, whereas an adjacent femto access point may have several hundred. For this reason, a simplistic uniform provisioning of allowable interferences is inadequate.

In contrast, the signaling channel between the FICM and the femto access point can be used to dynamically change interference settings based on dynamic, real-time circumstances. Note that femto management system 12 includes intelligence to identify certain femto access points that are disproportionately influencing interference levels. Hence, femto management system 12 is configured to adjust all femto access points, or to adjust individual femto access points based on its enhanced intelligence. This would allow femto management system 12 to downgrade specific femto access points, for example, in response to those particular femto access points contributing excessively to interference levels. This could return the system to an appropriate status quo such that RoT is no longer presenting a problem for the architecture.

In one particular example, based on the evaluated interference characteristics, signaling can be sent back to a femto access point to instruct the femto access point to reduce emitted power levels of attached UEs and, thereby, reduce interference. This is depicted in 190 of FIG. 4. Semantically, femto management system 12 is intelligently controlling offending interference emanating from certain UEs.

The exact mechanism for reducing interference may be prescribed in the signaling between femto management system 12 and femto access point 32, or it may be left up to the femto cell access point to execute this reduction in interference in any suitable manner. These activities are generally being summarized at 200. For example, the emitted power level of the handset can be decreased, which may ultimately lead to a downgrade in service. Stated differently, there can be service implications from the behavior of the femto access point in addressing the offending interference that was detected. In other examples, the femto access point can deny service to a given UE, which would eliminate that particular UE from contributing to additional interference. Note that, commonly, various standards have been adopted to allow a femto access point to control the maximum emission rates for individual UEs. Hence, femto access point 32 is empowered to control service levels, connectivity, any acceptance of new connectivity or access requests, etc. for UEs in its domain.

Note that in more specific operations, the UEs that request service later in time could theoretically suffer compared to those already receiving service. A broadcast message can be used for the UEs connected via femto access points in a given macrocell to reduce the transmission power. Logistically, the interactions from the femto access points to the UE may be constrained by Radio Resource Control (RRC) signaling. If RRC signaling supports broadcast messaging, then such messaging could be used. In other cases, where only a unicast technique is used for power control, a mechanism can be leveraged to translate between broadcast messages from the FICM to unicast messages for each UE.

Note that with the example of FIG. 4 provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and further can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the activities in FIG. 4 illustrate only some of the possible signaling scenarios and patterns that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access, and broadcast protocols, communication system 10 may be applicable to other exchanges, routing protocols, or routed protocols in which packets (not necessarily the routing protocol/packets described) are exchanged in order to provide resource allocation data, connectivity parameters, access management, etc. Moreover, although communication system 10 has been illustrated with reference to particular elements and operations that facilitate the communication process, these elements and operations may be replaced by any suitable architecture or process that achieves the intended functionality of communication system 10.

In a separate endeavor, communication system 10 may generally be configured or arranged to represent a 3G architecture applicable to UMTS environments in accordance with a particular embodiment. However, the 3G architecture is offered for purposes of example only and may alternatively be substituted with any suitable networking system or arrangement that provides a communicative platform for communication system 10. In other examples, FIG. 1 could readily include a serving general packet radio service (GPRS) support node (SGSN), a gateway GPRS support node (GGSN), any type of network access server (NAS), etc. and all of these elements could interface with an authentication, authorization, and accounting (AAA) server. Moreover, the present disclosure is equally applicable to other cellular and/or wireless technology including CDMA, Wi-Fi, WiMAX, etc.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
receiving interference information associated with a plurality of femto access points operating in a macro network;
evaluating the interference information;
determining that an interference threshold has been exceeded based on the interference information; and
communicating signaling information to a particular femto access point to reduce an interference level based on the interference information.

2. The method of claim 1, wherein the interference information includes rise over thermal (RoT) data.

3. The method of claim 1, further comprising:
establishing a connection between a femto management system and the particular femto access point in order to communicate the signaling information.

4. The method of claim 1, wherein the signaling information includes instructions for reducing the interference level.

5. The method of claim 1, wherein the particular femto access point reduces the interference level by degrading a service associated with a specific user equipment (UE).

6. The method of claim 1, wherein the interference information is indicative of interference levels generated by UEs attached to the plurality of femto access points.

7. The method of claim 1, wherein an identifier that is associated with a macrocell in which the plurality of femto cell access points are located, is embedded into a fully qualified domain name (FQDN), and is used to generate an identity for establishing a communication session to communicate the signaling information.

8. Logic encoded in one or more tangible media that includes code for execution and when executed by a processor operable to perform operations comprising:
receiving interference information associated with a plurality of femto access points operating in a macro network;
evaluating the interference information;
determining that an interference threshold has been exceeded based on the interference information; and
communicating signaling information to a particular femto access point to reduce an interference level based on the interference information.

9. The logic of claim 8, wherein the interference information includes rise over thermal (RoT) data.

10. The logic of claim 8, the operations further comprising:
establishing a connection between a femto management system and the particular femto access point in order to communicate the signaling information.

11. The logic of claim 8, wherein the signaling information includes instructions for reducing the interference level.

12. The logic of claim 8, wherein the particular femto access point reduces the interference level by degrading a service associated with a specific user equipment (UE).

13. The logic of claim 8, wherein the interference information is indicative of interference levels generated by UEs attached to the plurality of femto access points.

14. An apparatus, comprising:
a memory element configured to store electronic code;
a processor operable to execute instructions associated with the electronic code; and
an interference coordination module configured to interface with the processor such that the apparatus is configured for:
receiving interference information associated with a plurality of femto access points operating in a macro network;
evaluating the interference information;
determining that an interference threshold has been exceeded based on the interference information; and
communicating signaling information to a particular femto access point to reduce an interference level based on the interference information.

15. The apparatus of claim 14, wherein the interference information includes rise over thermal (RoT) data.

16. The apparatus of claim 14, wherein the signaling information includes instructions for reducing the interference level.

17. The apparatus of claim 14, wherein the particular femto access point reduces the interference level by degrading a service associated with a specific user equipment (UE).

18. The apparatus of claim 14, wherein the interference information is indicative of interference levels generated by UEs attached to the plurality of femto access points.

19. The apparatus of claim 14, wherein an identifier that is associated with a macrocell in which the plurality of femto cell access points are located, is embedded into a fully qualified domain name (FQDN), and is used to generate an identity for establishing a communication session to communicate the signaling information.

20. The apparatus of claim 14, wherein the particular femto access point is configured for estimating a level of interference being generated by a plurality of UEs, and wherein the estimating includes using path loss data.
